(19) United States
(12) Patent Application Publication
(10) Pub. No.: US 2016/0176201 A1
(43) Pub. Date: Jun. 23, 2016

(54) METHOD FOR IMAGE FORMATION AND TEXTILE FIBER PRODUCTS

(71) Applicant: MATSUI SHIKISO CHEMICAL CO., LTD., KYOTO (JP)

(72) Inventors: Yosuke KITAGAWA, KYOTO (JP); Masaki KARIYA, KYOTO (JP); Hirofumi SHIMOKAWA, KYOTO (JP); Daisuke INOUE, KYOTO (JP)

(21) Appl. No.: 14/957,194

(22) Filed: Dec. 2, 2015

(30) Foreign Application Priority Data
Dec. 22, 2014 (JP) 2014-259361

(51) Int. Cl. B41J 3/407; D06M 15/564; C09D 11/03; C09D 11/30; C09D 11/10

(52) U.S. Cl. CPC B41J 3/4078; C09D 11/30; C09D 11/10; C09D 11/03; D06M 15/564

(57) ABSTRACT

An ink adsorption layer formation step for forming an ink adsorption layer by screen-printing a liquid or pasty binder composition for ink adsorption layer formation on a required portion of a textile fiber product directly or via another layer, and an inkjet step for forming an image by applying, using an inkjet process, an aqueous pigment ink to an ink adsorption layer formed through the ink adsorption layer formation step are present, and the binder composition for ink adsorption layer formation contains inorganic porous microparticles having a specific surface area of not less than 200 m²/g to adsorb the aqueous pigment ink applied using the inkjet process.

### BACKGROUND OF THE INVENTION

1. Field of the Invention The present invention relates to a method for image formation wherein an image is formed on a textile fiber product by applying an aqueous pigment ink using an inkjet process and a textile fiber product obtained thereby.

2. Description of the Prior Art

Pigment printings using a hand screen, autonomous-travelling or belt-conveyor type automatic screen printing machines, automatic circular screen printing machines, or the like have heretofore been used to form images such as characters or patterns on textile fiber products such as T-shirts or sweat shirts.

In these printing methods, highly viscous binder compositions colored in each color are printed in desired designs on a textile fiber product using 60- to 150-mesh screen plates.

In the case of T-shirts, sweat shirts, or the like that are chromatic, a method is used wherein a white masking layer binder composition is previously printed on such a textile fiber product in accordance with an image to be formed, and binder compositions in various colors are printed in a stack thereon.

When printing a multicolor, complex design in such a conventional printing method, a large number of screen plates are required, resulting in a great burden of plate cost and increased days before delivery. Furthermore, it is difficult to express a photograph-like design or fine design on fiber because an image is printed on the fiber via a 60- to 150-mesh screen plate; if using a high-mesh size, such as 200 meshes, for printing, the screen plate is likely to clog, making it practically difficult to achieve photographically faithful, uniform printing.

In recent years, pigment ink printing using an inkjet process has been developed because of its ability to print a fine image on a textile fiber product without using a printing plate (JP-A-2003-268271).

However, such an inkjet ink lacks concealing performance; therefore, if wanting to form an image on a chromatic textile fiber product, it is unlikely to obtain a brilliant image of high density due to the color of the textile fiber product per se, although the ink is suitable for the formation of an image on a white textile fiber product.

To solve this issue, there have been proposed a method wherein a discharge printing ink is printed on a chromatic textile fiber product, after which a desired coloring ink is printed using an inkjet process (JP-4668558) and a method wherein a white concealing ink containing titanium dioxide is undercoat-printed using an inkjet process, after which inks of various colors are printed using an inkjet process to form an image (JP-4969578).

However, in the case of the former method, which uses a discharge printing ink, the discharge printing status varies depending on the kind of the fiber of the subject textile fiber product, the kind of the dye by which the fiber is colored, and the like; even if a coloring ink is printed on a discharge-printed portion, it is unlikely that a brilliant image is formed because the ink penetrates easily in the fiber product.

In addition, the white concealing ink used in the latter method lacks storage stability because the titanium dioxide contained therein has a high specific gravity and is likely to sediment. In addition, since the white concealing ink necessitates a reduction of the content amount of binding agent to achieve s table printing using an inkjet process, the bindability to textile fiber product is likely to be inadequate, and the fastness of the undercoating layer formed by the white concealing ink is unlikely to be adequate. Furthermore, too long printing time is needed to ensure desired concealing performance for the undercoating layer formed by printing the white concealing ink using an inkjet process.

### SUMMARY OF THE INVENTION

A problem to be solved by one aspect of the present invention is to provide a method for image formation making it possible to form an image with higher brilliancy and higher density, as well as a soft feeling and excellent fastness, on a textile fiber product, in a relatively short time, and a textile fiber product with an image formed thereon using the method.

The present inventors conducted extensive researches to found that by applying, using an inkjet process, an aqueous pigment ink to an ink adsorption layer formed by screen -printing a liquid or pasty binder composition for ink adsorption layer formation containing inorganic porous microparticles having a specific surf ace area of not less than 200 m²/g on a required portion of a textile fiber product directly or via another layer to form an image, the aqueous pigment ink is adsorbed to the surface of the ink adsorption layer and prevented from penetrating the fiber of the textile fiber product, making it possible to form a brilliant image of high density, and have developed the present invention.

The method for image formation and a textile fiber product with an image formed thereon using the method in one or more embodiments of the present invention can be described as follows:

(1) A method for image formation on a textile fiber product, including an ink adsorption layer formation step for forming an ink adsorption layer by screen-printing a liquid or pasty binder composition for ink adsorption layer formation on a required portion of the textile fiber product directly or via another layer, and
an inkjet step for forming an image by applying, using an inkjet process, an aqueous pigment ink to the ink adsorption layer formed through the ink adsorption layer formation step,
wherein the binder composition for ink adsorption layer formation contains inorganic porous microparticles having a specific surface area of not less than 200 m²/g to adsorb the aqueous pigment ink applied using the inkjet process.

(2) The method for image formation in (1) above, wherein the region of the ink adsorption layer formed through the ink adsorption layer formation step and the region of the image formed through the inkjet step coincide substantially with each other.

(3) The method for image formation in (1) or (2) above, wherein the required portion of the textile fiber product is chromatic.

(4) The method for image formation in any one of (1) to (3) above, wherein the ink adsorption layer is in a wet state when applying the aqueous pigment ink to the ink adsorption layer using an inkjet process.

(5) The method for image formation in any one of (1) to (4) above, wherein the inorganic porous microparticles are at least one kind of inorganic porous microparticles selected from among silicon dioxide, aluminosilicate and bentonite, and those cationized with a cationic compound.

(6) The method for image formation in any one of (1) to (5) above, wherein the binder composition for ink adsorption layer formation contains titanium dioxide to improve the concealing performance of the ink adsorption layer.

(7) The method for image formation in any one of (1) to (6) above, wherein the binder composition for ink adsorption layer formation contains a cationic compound.

(8) The method for image formation in any one of (1) to (7) above, wherein the binder composition for ink adsorption layer formation contains a discharging agent.

(9) The method for image formation in any one of (1) to (8) above, wherein the ink adsorption layer formation step is for forming an ink adsorption layer by screen-printing a liquid or pasty binder composition for ink adsorption layer formation on the required portion of the textile fiber product directly or via a white masking layer, the white masking layer containing titanium dioxide.

(10) The method for image formation in any one of (1) to (8) above, wherein the ink adsorption layer formation step is for forming an ink adsorption layer by screen-printing a liquid or pasty binder composition for ink adsorption layer formation on the required portion of the textile fiber product directly or via a sublimation contamination prevention layer or a white masking layer formed via a sublimation contamination prevention layer, the sublimation contamination prevention layer containing activated charcoal.

(11) The method for image formation in any one of (1) to (10) above, wherein the amount of the binder composition for ink adsorption layer formation applied to the textile fiber product directly or via another layer is 40 to 200 g/m².

(12) The method for image formation in any one of (1) to (11) above, wherein the aqueous pigment ink used for the step for image formation contains at least
(A) a pigment,
(B) a water-soluble polymeric dispersing agent,
(C) an aqueous liquid as a solvent or disperse medium,
(D) a self-emulsifying urethane resin, and
(E) a block isocyanate compound.

(13) The method for image formation in any one of (1) to (12) above, having a heat treatment step for performing a heat treatment at 100 to 220 degrees Celsius for 1 to 10 minutes for at least the portion of the textile fiber product with an image formed thereon with the aqueous pigment ink.

(14) The method for image formation in any one of (1) to (13) above, having a post-treatment step for performing a post-treatment by applying a post-treating agent to at least the portion of the textile fiber product with an image formed thereon with the aqueous pigment ink.

(15) The method for image formation in (14) above,

wherein the post-treating agent is at least one kind of acrylic resin emulsion, urethane resin emulsion, crosslinking agent, plasticizer, surfactant, flame retardant, silicone-based softening agent, and fluorine-based water repellent, and
the post-treatment step contains performing a heat treatment at 100 to 180 degrees Celsius for 10 to 180 seconds for at least the portion of the textile fiber product with the post-treating agent applied thereto.

(16) A textile fiber product obtained using the method for image formation in any one of (1) to (15) above.

According to one aspect the present invention, by applying an aqueous pigment ink using an inkjet process to form an image on an ink adsorption layer formed by screen printing a liquid or pasty binder composition for ink adsorption layer formation containing inorganic porous microparticles having a specific surface area of not less than 200 m²/g on a required portion of a textile fiber product directly or via another layer, the aqueous pigment ink is adsorbed to the surf ace of the ink adsorption layer and prevented from penetrating the textile fiber product, making it possible to form a brilliant image of high density.

In addition, ink adsorption layer formation is achieved by screen printing, and image formation is achieved by applying an aqueous pigment ink using an inkjet process; therefore, the screen plate preparation time and cost as a whole can be reduced, and the time needed for ink adsorption layer formation per se is shortened, compared with the use of an inkjet process, making it possible to perform image formation on a textile fiber product as a whole in a shorter time.

### DETAILED DESCRIPTION OF THE INVENTION

Modes of embodiment of the present invention are described below.

### (1) Method for Image Formation

The method for image formation of the present invention includes an ink adsorption layer formation step for forming an ink adsorption layer by screen printing a liquid or pasty binder composition for ink adsorption layer formation on a required portion of a textile fiber product directly or via another layer (e.g., either a white masking layer or a sublimation contamination prevention layer, or both), and an inkjet step for applying an aqueous pigment ink to the ink adsorption layer formed through the ink adsorption layer formation step using an inkjet process to form an image, the binder composition for ink adsorption layer formation containing inorganic porous microparticles having a specific surface area of not less than 200 m²/g to adsorb the aqueous pigment ink applied using the inkjet process.

### (2) Textile Fiber Product

Textile fiber products that can serve as subjects for the method for image formation of the present invention include material cloths made of woven fabrics, knits, felt or non-woven fabrics configured with various fibers or products made thereof (secondary products or tertiary or higher products).

Textile fiber products preferred as subjects for the method of image formation of the present invention are chromatic textile fiber products, i.e., non-white textile fiber products.

The aforementioned knits include “meriyasu” (knitted cloths), and the aforementioned material cloth, i.e. woven fabrics, knits, felts, or non-woven fabrics include gigged cloths.

The aforementioned secondary products or tertiary or higher products include garments (T-shirts, sweatshirts, jerseys, pants, one-piece dresses, blouses, hats and caps, socks, and the like), apparel accessories (handkerchiefs, neckties, cloth belts, and the like), and other products (shoes, beddings, curtains, carpets, wall cloths, bags, flags, and the like). Even those having a portion configured with a non-fiber component are, as a rule, not excluded from the scope of the subject.

The fiber that constitutes the textile fiber product, as a rule, is also subject to no limitations; examples include textile fiber products configured with any of various synthetic fibers, semi-synthetic fibers, natural fibers, and inorganic fibers (including blended yarn thereof) such as nylon, polyester, acrylic fiber, lactate fiber, acetate, rayon, cotton, silk, wool, hemp, and glass fiber.

### (3) Ink Adsorption Layer Formation Step

The ink adsorption layer formation step in the present invention is performed by screen-printing a liquid or pasty binder composition for ink adsorption layer formation on a required portion of a textile fiber product directly or via another layer to form an ink adsorption layer with the binder composition for ink adsorption layer formation. Formation of an ink adsorption layer can also be achieved by a plurality of times of stacking application.

For this screen printing, an 80- to 200-mesh screen plate, for example, can be used suitably.

In allowing an image to be formed through an inkjet step with a higher brilliancy and higher density without influencing the appearance and touch properties, such as color, pattern, and feeling, of a portion of the textile fiber product, other than the portion on which an image is formed with the aqueous pigment ink, it is preferable that the region of the ink adsorption layer formed through the ink adsorption layer formation step on the textile fiber product, and the region of the image formed through the inkjet step coincide substantially with each of her (regions as mentioned herein encompasses not only planar regions, but also linear and punctate regions).

To allow the region of the ink adsorption layer and the region of the image formed through the inkjet step to coincide substantially with each other, it is important to precisely form the ink adsorption layer. In some cases, it may be necessary to precisely form an ink adsorption layer on a required region that does not always coincide with the region of the image. Hence, to precisely form an ink adsorption layer, it is desirable that the ink adsorption layer be formed by screen-printing a binder composition for ink adsorption layer formation. Binder compositions for ink adsorption layer formation containing inorganic porous microparticles having a specific surface area of not less than 200 m²/g are not suitable as an ink for inkjet printing.

### (4) Binder Composition for Ink Adsorption Layer Formation

The binder composition for ink adsorption layer formation applied in a liquid or pasty form to a required portion of a textile fiber product directly or via another layer in the ink adsorption layer formation step in the present invention contains inorganic porous microparticles having a specific surface area of not less than 200 m²/g to adsorb the aqueous pigment ink applied using an inkjet process.

The aforementioned binder composition for ink adsorption layer formation may contain as required, in addition to the afore mentioned inorganic porous microparticles (capable of exhibiting concealing performance depending on the type and content amount), titanium dioxide or another concealing pigment for improving the concealing performance (performance for preventing the color, pattern, and the like of the ink adsorption-layer-covered portion of a textile fiber product from appearing on the surface side of the ink adsorption layer) of the ink adsorption layer formed, a cationic compound for improving the adsorption capacity to adsorb the aqueous pigment ink applied using an inkjet process, a discharging agent for discharging the color of the subject textile fiber product, a crosslinking agent for improving the fastness of the ink adsorption layer formed, and the like.

The aforementioned binder composition for ink adsorption layer formation can be obtained by blending as appropriate, in addition to the aforementioned components, water and a binding agent, as well as a dispersing agent, thickener, drying retarder, plasticizer, antioxidant, defoaming agent, ultraviolet absorbent, pH regulator, and the like as appropriate.

The amount of the binder composition for ink adsorption layer formation applied to the textile fiber product directly or via another layer is preferably 40 to 200 g/m². If the a mount is less than 40 g/m², aqueous pigment ink fixation is likely to be inadequate, and if the amount is more than 200 g/m², a large amount of the binder is likely to impregnate in the fiber and adversely affect the feeling.

### (4-1) Inorganic Porous Microparticles

When applying an aqueous pigment ink to the ink adsorption layer formed, using an inkjet process, inorganic porous microparticles having a specific surface area of not less than 200 m²/g act to adsorb the aqueous pigment ink to the ink adsorption layer, and are an essential component of the binder composition for ink adsorption layer formation in the present invention.

If applying an aqueous pigment ink to an ink adsorption layer formed with a binder composition not containing such inorganic porous microparticles, using an inkjet process, failures such as aqueous pigment ink color development density reductions, cissing, and mottling are likely to occur, making it difficult to form a desired brilliant image of high density.

If the specific surface area of the inorganic porous microparticles contained in the binder composition for ink adsorption layer formation to adsorb the aqueous pigment ink is less than 200 m²/g, the ad sorption capacity of the ink adsorption layer, i.e., the adsorption capacity to adsorb the aqueous pigment ink applied to the ink adsorption layer using an inkjet process, will be poor, making bleeding and mottling to likely to occur.

Specific examples of inorganic porous microparticles that can be used as the afore mentioned inorganic porous microparticles in the present invention include, but are not limited to, silicon dioxide, aluminosilicate, bentonite, and those cationized with a cationic compound, i.e. cationized silicon dioxide, cationized aluminosilicate, cationized bentonite. A plurality of kinds of inorganic porous microparticles may be used in combination.

The content amount of inorganic porous microparticles may be, for example, 0.1 to 15% by weight, prefer ably 0.5 to 10% by weight, more preferably 1 to 5% by weight, relative to the binder composition for ink adsorption layer formation.

### (4-2) Titanium Dioxide (Concealing Pigment)

To improve the concealing performance of the ink adsorption layer formed, titanium dioxide may be blended in the binder composition for ink adsorption layer formation as required. The titanium dioxide used may be of any one of the anatase type, brookite type, and rutile type, for example, with preference given to the rutile type because of the high concealing performance thereof.

The content amount of titanium dioxide may be, for example, 1 to 40% by weight, preferably 5 to 35% by weight, more preferably 10 to 25% by weight, relative to the binder composition for ink adsorption layer formation.

### (4-3) Cationic Compound

To improve the aqueous pigment ink ad sorption capacity of the ink adsorption layer formed, by cationizing the surface of the ink adsorption layer to allow an ion complex to be formed between the aqueous pigment ink (usually anionic) applied to the ink adsorption layer using an inkjet process and the ink adsorption layer, a cationic compound may be blended in the binder composition for ink adsorption layer formation.

Examples of useful cationic compounds include polyvalent metal salts, surfactants having a tertiary amino group or a quaternized salt thereof, and polymers having a tertiary amino group or a quaternized salt thereof. More specifically, such cationic compounds include, but are not limited to, calcium chloride, calcium acetate, calcium nitrate, magnesium sulfate, dimethyllaurylamine, dimethylstearylamine, dilaurylmonomethylamine, lauryltrimethylammonium chloride, didecyldimethylammonium chloride, polyallylamine, polyallylamine hydrochloride, modified polyvinyl alcohols having a quaternary ammonium salt in a side chain thereof, polyamide epichlorohydrin, and vinyl resin compounds having a quaternary ammonium salt at the molecular end thereof.

The content amount of the cationic compound may be, for example, 0.1 to 10% by weight, prefer ably 0.5 to 5% by weight, more preferably 0.5 to 3% by weight, relative to the binder composition for ink adsorption layer formation.

### (4-4) Discharging Agent

For the purpose of discharge printing of the textile fiber product to which a binder composition for ink adsorption layer formation is applied to form an image, a discharging agent may be blended in the binder composition for ink adsorption layer formation.

As the discharging agent used, a reduction discharging agent, oxidation discharging agent, and the like are chosen according to the coloring agent for the subject textile fiber product. More specifically, examples include, but are not limited to, hydrosulfites, thiourea dioxide, sodium hydrogen sulfite, sodium thiosulfate, stannous chloride, sodium chlorite, Rongalit, and Decroline. A pH regulator may also be blended in the binder composition for ink adsorption layer formation to increase the discharge printing effect.

In the steps that follow, heat treatment, water washing, and the like are performed as required to increase the discharge printing effect.

### (4-5) Crosslinking Agent

To improve the fastness of the ink adsorption layer to be formed, a crosslinking agent may be blended in the binder composition for ink adsorption layer formation.

The crosslinking agent used may be one that reacts with a functional group present in the binding agent contained in the binder composition for ink adsorption layer formation. Specific examples include, but are not limited to, oxazoline compounds, isocyanate compounds, block isocyanate compounds, aziridine compounds, and epoxy compounds. A plurality of such compounds can be used in combination. Preferably, the crosslinking agent is a block isocyanate compound that can be used as a single liquid, with greater preference given to an aliphatic or alicyclic block isocyanate compound in preventing the ink adsorption layer formed from yellowing due to the influence of light, gaseous nitrogen oxide, and the like.

### (4-6) Binding Agent

The binding agent to be blended in the binder composition for ink adsorption layer formation in the present invention may be one capable of conferring good fastness (washing fastness, friction fastness, dry cleaning resistance, and the like) to the ink adsorption layer formed by applying the binder composition for ink adsorption layer formation to a required portion of a textile fiber product. For example, resins of excellent fastness, such as acrylic resin, urethane resin, EVA resin, and polyester resin are suitable.

The content amount of binding agent may be, for example, 20 to 60% by weight, preferably 25 to 50% by weight, more preferably 30 to 40% by weight, relative to the binder composition for ink adsorption layer formation.

The glass transition point (Tg) of the binding agent blended in the binder composition for ink adsorption layer formation in the present invention, when applying the binder composition for ink adsorption layer formation to a textile fiber product to form an ink adsorption layer, is preferably in the range of −60 degrees Celsius to 20 degrees Celsius, more preferably −40 to 0 degrees Celsius, still more preferably −20 to −10 degrees Celsius, in making the textile fiber product soft without affecting the feeling of the fiber.

### (5) White Masking Layer

The above-described ink adsorption layer formation step may be such that an ink adsorption layer is formed with a liquid or pasty binder composition for ink adsorption layer formation on a required portion of a textile fiber product directly or via a white masking layer (or a white masking layer formed via a sublimation contamination prevention layer and the like). The white masking layer is capable of preventing the color, pattern, and the like of the textile fiber product from appearing on the surface side.

In this case, the white masking layer can be formed on all or a portion of the required portion of the textile fiber product directly or via another layer.

When forming an ink adsorption layer with a binder composition for ink adsorption layer formation via a white masking layer (or a white masking layer formed via another layer), the necessity for blending a concealing pigment, such as titanium dioxide, in the binder composition for ink adsorption layer formation decreases because the white masking layer possesses concealing performance.

Formation of a white masking layer on a textile fiber product directly or via another layer can be achieved by forming a white masking layer with a liquid or pasty binder composition for white masking layer formation.

Such formation of a white masking layer on a textile fiber product directly or via another layer can be achieved by screen-printing a binder composition for white masking layer formation directly on the textile fiber product or on another layer formed on the textile fiber product. In precisely forming a white masking layer, screen printing is preferred. For this screen printing, an 80- to 200-mesh screen plate, for example, can be used suitably.

The binder composition for white masking layer formation in the present invention can be obtained by blending as appropriate, in addition to titanium dioxide or another concealing pigment, water and a binding agent, as well as a dispersing agent, thickener, drying retarder, plasticizer, antioxidant, defoaming agent, ultraviolet absorbent, pH regulator, and the like as appropriate.

The content amount of titanium dioxide or another concealing pigment in the binder composition for white masking layer formation may be, for example, 1 to 40% by weight, preferably 5 to 35% by weight, more preferably 10 to 25% by weight.

The amount of the binder composition for white masking layer formation applied to the textile fiber product is preferably 50 to 120 g/m². If the amount applied is less than 50 g/m², the concealing performance is likely to be inadequate, and if the amount applied is more than 120 g/m², a large amount of the binder is likely to impregnate in the fiber and adversely affect the feeling.

### (6) Sublimation Contamination Prevention Layer

The above-described ink adsorption layer formation step may be such that an ink adsorption layer is formed with a liquid or pasty binder composition for ink adsorption layer formation on a required portion of a textile fiber product directly or via a sublimation contamination prevention layer (or a white masking layer and the like formed via a sublimation contamination prevention layer). If the textile fiber product has been colored with a sublimating dye, the sublimation contamination prevention layer is capable of preventing the ink adsorption layer and images from being contaminated due to dye sublimation and the like.

In this case, the sublimation contamination prevention layer can be formed on all or a portion of the required portion of the textile fiber product directly or via another layer.

It is preferable that a sublimation contamination prevention layer be provided when the subject textile fiber product has been colored with a sublimating dye like in cases where the subject textile fiber product consists of a polyester fiber that has been died with a disperse dye; a sublimation contamination prevention layer is not always necessary when the subject textile fiber product consists of a fiber (e.g., cotton, nylon, rayon, hemp, wool, silk, and the like) that has been colored with a non-sublimating dye.

Formation of a sublimation contamination prevention layer on a textile fiber product directly or via another layer can be achieved by forming a sublimation contamination prevention layer with a liquid or pasty binder composition for sublimation contamination prevention layer formation.

Such formation of a sublimation contamination prevention layer on a textile fiber product directly or via another layer can be achieved by screen-printing a binder composition for sublimation contamination prevention layer formation directly on the textile fiber product or on another layer formed on the textile fiber product. In precisely forming a sublimation contamination prevention layer, screen printing is preferred. For this screen printing, an 80- to 200-mesh screen plate, for example, can be used suitably.

A binder composition for sublimation contamination prevention layer formation can be obtained by blending activated charcoal for adsorbing sublimated dyes and the like, water, and a binding agent, as well as a dispersing agent, thickener, drying retarder, plasticizer, antioxidant, defoaming agent, ultraviolet absorbent, pH regulator, and the like as appropriate.

The amount of the binder composition for sublimation contamination prevention layer formation applied to the textile fiber product is preferably 50 to 120 g/m². If the amount is less than 50 g/m², the prevention of sublimation contamination is likely to be inadequate, and if the amount is more than 120 g/m², a large amount of binder is likely to impregnate in the fiber and adversely affect the feeling.

### (7) Inkjet Step

The inkjet step in the present invention is performed by applying an aqueous pigment ink to the ink adsorption layer formed through the ink adsorption layer formation step, using an inkjet process, to form an image. When applying the aqueous pigment ink, the ink adsorption layer may have been dried; however, a wet state is preferable because an image more brilliantly colored with the aqueous pigment ink is easier to obtain, and because an image with excellent fastness and a softer feeling is easier to obtain by reducing the relative amount of binding agent. Furthermore, applying an aqueous pigment ink to an ink adsorption layer in a wet state is also preferred in terms of operating efficiency because there is no need for a step for drying the ink adsorption layer.

In cases where a crosslinking agent is blended in the binder composition for ink adsorption layer formation and/or aqueous pigment ink, by applying an aqueous pigment ink to an ink adsorption layer (particularly an ink adsorption layer in a wet state) using an inkjet process to form an image, they can crosslink with a functional group of the binding agent that can be contained in the binder composition for ink adsorption layer formation and/or functional group(s) of both or either of the dispersing agent and binding agent that can be contained in the aqueous pigment ink, becoming a water-insoluble integral entity, and, while in a state containing the pigment in the aqueous pigment ink, binding firmly to the fiber in the textile fiber product. It is possible to form a soft image of excellent fastness because there is no need for a large amount of binding agent.

### (8) Aqueous Pigment Ink

The aqueous pigment ink used in the inkjet step in the present invention is intended to form an image by being applied to a portion or all of the ink adsorption layer formed on a required portion of a textile fiber product, by an inkjet process using an inkjet printing machine or the like.

This aqueous pigment ink is generally an ink having yellow, magenta, cyan, and black as the base colors, which, however, are not to be construed as limiting. For example, aqueous pigment inks in green, blue, red, scarlet, orange, violet, and other colors can also be used.

In the inkjet step in the present invention, an aqueous pigment ink containing at least a pigment, a dispersing agent, an aqueous liquid as a solvent or disperse medium, a binding agent, and a crosslinking agent can be used suitably.

Such an aqueous pigment ink can be obtained by, for example, obtaining a pigment dispersion containing at least a pigment, a dispersing agent, and an aqueous liquid as a solvent or disperse medium, then blending the pigment dispersion obtained and a binding agent, a crosslinking agent, and an aqueous liquid as a solvent or disperse medium (and an antioxidant, defoaming agent, and the like added as required), and an aqueous pigment ink having its surface tension adjusted to 20 to 40 mN/m and its viscosity adjusted to 3 to 30 mPa/s at 20 degrees Celsius, can be used preferably.

The aforementioned pigment dispersion can be obtained by, for example, wet-dispersing a blend of a pigment, an aqueous liquid as a solvent or disperse medium, a dispersing agent, and the like using glass beads, zirconia beads, titania beads, or the like in a milling machine (beads mill).

The aforementioned pigment dispersion may be, for example, one containing a pigment solid at 5 to 50% by weight, which, however, is not to be construed as limiting.

In the inkjet step of the present invention, an aqueous pigment ink blended as appropriate with, for example, a thickener, an ultraviolet absorbent, an antioxidant, a wax, a defoaming agent, an anti-settling agent, a crosslinking catalyst, a chelating agent, a surfactant, and the like as components other than the above-described ones, and filtered through a filter or centrifuged to remove coarse particles not smaller than 1 micro m, can be used suitably.

### (8-1) Pigment

As the pigment used in the aqueous pigment ink in the present invention, any pigment serving as a coloring material can be useful as a rule, whether it is an organic pigment or an inorganic pigment.

Specifically, for example, black pigments such as carbon black and iron oxide black pigment; yellow pigments such as azo pigments, imidazolone pigments, and titanium yellow pigments; orange pigments such as indanthrene pigments; red pigments such as azo pigments, quinacridone pigments, chromophtal pigments, diketopyrrolopyrrole pigments, anthraquinone pigments; blue pigments such as phthalocyanine pigments; purple pigments such as dioxadine pigments; green pigments such as phthalocyanine pigments; and the like can be used, which, however, are not to be construed as limiting.

### (8-2) Dispersing Agent

Although surfactant-based dispersing agents, polymeric dispersing agents, and the like can be used as the dispersing agent used in the aqueous pigment ink in the present invention, water-soluble polymeric dispersing agents are suitably used from the viewpoint of the storage stability and fastness of the aqueous pigment ink.

Useful water-soluble polymeric dispersing agents include, for example, an emulsion polymer prepared from an aliphatic vinyl monomer possessing crosslinking reactivity and a (meth)acrylic ester monomer, styrene, or the like that is copolymerizable therewith, neutralized with a basic substance.

Examples of the aforementioned aliphatic vinyl monomer possessing crosslinking reactivity include, but are not limited to, those having a carboxyl group, such as acrylic acid, methacrylic acid, itaconic acid, maleic acid, and fumaric acid, as well as (meth)hydroxyacrylate, (meth)acrylonitrile, acrylamide, and epoxy group-containing vinyl monomer. These aliphatic vinyl monomers may be used alone, or in combination of two kinds or more.

The aforementioned (meth)acrylic ester monomer, styrene, or the like is effectively used to increase the water resistance, dispersion stability, and temporal stability of the viscosity of the aqueous pigment ink.

A water-soluble polymeric dispersing agent can be obtained by neutralizing an emulsion polymer obtained therefrom with a basic substance. Here, the basic substance used as a neutralizer include, for example, ammonia, basic metal salts, primary amine compounds, secondary amine compounds, tertiary amine compounds, and the like.

### (8-3) Aqueous Liquid

In the aqueous pigment ink in the present invention, an aqueous liquid is used as a solvent or disperse medium.

Water or a mixture of water and a water-soluble organic solvent, and the like can be used as the aqueous liquid.

Examples of water-soluble organic solvents that can be used for the purpose of adjusting the wettability, solubility, surface tension, viscosity, drying speed, and the like include, but are not limited to, glycols such as ethylene glycol, diethylene glycol, triethylene glycol, propylene glycol, and butylene glycol; glycerins such as glycerin and diglycerin; alcohols such as methanol, ethanol, n-propanol, isopropanol, n-butanol, isobutanol, and t-butanol; as well as 2-pyrrolidone, propylene glycol monomethyl ether, ethylene glycol monoethyl ether, ethylene glycol monomethyl ether, methyl ethyl ketone, ethyl acetate, and ethylene glycol mono n-butyl ether. Such water-soluble organic solvents may be used alone or in combination of two kinds or more.

### (8-4) Binding Agent

Examples of binding agents that can be used in the aqueous pigment ink in the present invention include acrylic resin, urethane resin, EVA resin, and the like as water-soluble resins, self-emulsifying resins or forcibly emulsified resins.

Of them, self-emulsifying urethane resins are suitable in term s of discharge stability and storage stability of aqueous pigment ink in the inkjet printing machine, and the fastness of the image formed with aqueous pigment ink using an inkjet process. Of self-emulsifying urethane resins, those prepared from an aliphatic or a licyclic isocyanate as a raw material are preferred to prevent the image formed using an inkjet process from yellowing due to the influence of light, gaseous nitrogen oxide, and the like.

If the amount blended of a self -emulsifying urethane resin as binding agent or another binding agent in the aqueous pigment ink is large, the fastness of the image formed will improve, but its feeling hardens.

Therefore, the amount of self-emulsifying urethane resin as binding agent or another binding agent blended in the aqueous pigment ink in the present invention can be, for example, 1 to 30% by weight, preferably 1 to 20% by weight, more preferably 1 to 15% by weight.

For maintaining the feeling and elasticity of textile fiber product, the 100% modulus of a self-emulsifying urethane resin as binding agent or another binding agent can be, for example, 0.1 to 30 MPa, preferably 0.1 to 15 MPa.

### (8-5) Crosslinking Agent

A crosslinking agent may be blended in the aqueous pigment ink in the present invention to improve the washing and friction fastness of the image formed.

Examples of such crosslinking agents include block isocyanate compounds capable of becoming water-insoluble and bind firmly to the textile fiber product by crosslinking with the functional group(s) of both or either of the dispersing agent and binding agent that can be contained in the aqueous pigment ink.

The block isocyanate compound blended in the aqueous pigment ink in the present invention is preferably one rendered water-soluble or self-emulsifying by providing a hydrophilic group. The aqueous pigment ink blended with such a water-soluble or self-emulsifying block isocyanate compound can be made to be of low viscosity and excellent redispersibility.

### (9) Printing Methods

### (9-1) Screen Printing

Formation of each of an ink adsorption layer, white masking layer, and sublimation contamination prevention layer by screen printing the aforementioned binder composition for ink adsorption layer formation, binder composition for white masking layer formation, and binder composition for sublimation contamination prevention layer formation, respectively, can be achieved by, for example, hand screen printing or printing using an automatic circular screen printing machine, and the like.

As stated above, when applying an aqueous pigment ink to an ink adsorption layer formed through an ink adsorption layer formation step using an inkjet process to form an image, the ink adsorption layer may be in a wet state or may have been dried. Drying can be achieved not only by spontaneous drying, but also by thermal drying.

When a white masking layer has been formed, the white masking layer may be in a wet state or may have been dried when forming an ink adsorption layer on the white masking layer. Drying can be achieved not only by spontaneous drying, but also by thermal drying.

Likewise, when a sublimation contamination prevention layer has been formed, the sublimation contamination prevention layer may be in a wet state or have been dried when forming an ink adsorption layer or a white masking layer on the sublimation contamination prevention layer. Drying can be achieved not only by spontaneous drying, but also by thermal drying.

Such thermal drying can be performed by performing a heat treatment at 100 to 180 degrees Celsius for 10 to 180 seconds for at least a portion of a textile fiber product with an ink adsorption layer, white masking layer, or sublimation contamination prevention layer, which is to be dried, provided thereon, using, for example, an air supply drier, hot-pressing machine, flash dryer, and the like.

### (9-2) Inkjet Step

The inkjet step in the present invention is performed by, as stated above, applying an aqueous pigment ink to an ink adsorption layer formed through an ink adsorption layer formation step using an inkjet process to form an image, and application of an aqueous pigment ink using an inkjet process can be achieved by printing an aqueous pigment ink using an inkjet printing machine.

The choice of inkjet printing machine for printing an aqueous pigment ink by an inkjet process is not particularly limited, but one having a piezo type nozzle head is preferred.

Examples of such printing machines include, but are not limited to, EPSON PX-V700, EPSON PM-4000PX, Mimaki TX-16005, FUJIFILM DMP-2831, and MASTERMIND MMP8130 (all are trade names).

### (10) Heat Treatment Step

The method for image formation of the present invention may have a heat treatment step for performing a heat treatment (e.g., at 100 to 220 degrees Celsius for 1 to 10 minutes) for at least a portion of a textile fiber product on which an image has been formed with the above-described aqueous pigment ink (or a portion on which an image has been formed with the aqueous pigment ink and a portion on which each of the above-described layers have been formed).

If a cross linking agent is blended in the binder composition for ink adsorption layer formation and/or aqueous pigment ink, the crosslinking agent surely crosslinks with a functional group of the binding agent that can be contained in the binder composition for ink adsorption layer formation and/or functional group(s) of both or either of the dispersing agent and binding agent that can be contained in the aqueous pigment ink by a required heat treatment, they become a water-insoluble integral entity, and, while in a state containing the pigment in the aqueous pigment ink, bind firmly to the fiber in the textile fiber product, whereby a pigment-colored textile fiber product is obtained. It is possible to form a soft image of excellent fastness while using a reduced amount of binding agent.

Heating temperature and heating time for the heat treatment are set, taking into account the heat resistance of the subject textile fiber product and the physical properties of the substances used in the various layers and the aqueous pigment ink, and the like. To ensure an adequate crosslinking reaction, the heat treatment is performed at 100 to 220 degrees Celsius for 1 to 10 minutes, preferably at 100 to 180 degrees Celsius for 1 to 10 minutes, more preferably at 120 to 160 degrees Celsius for 2 to 5 minutes.

### (11) Post-Treatment Step

The method for image formation of the present invention may have a post-treatment step for performing a post-treatment applying a post-treating agent to at least a portion of a textile fiber product on which an image has been formed with the above-described aqueous pigment ink (or a portion on which an image has been formed with the aqueous pigment ink and a portion on which each of the above-described layers have been formed) after the above-described heat treatment step if required.

The post-treating agent may be at least one kind of acrylic resin emulsion, urethane resin emulsion, crosslinking agent, plasticizer, surfactant, flame retardant, silicone-based softening agent, and fluorine-based water repellent.

Application of a post-treating agent to the required portion can b e achieved by a padding process, coating process, screen printing process, inkjet process, spraying process, or the like. Required additives such as an antistatic agent, ultraviolet absorbent, antioxidant, defoaming agent, and drying inhibitor may also be blended in these post-treating agents.

The post-treatment step may include performing a heat treatment (e.g., at 100 to 180 degrees Celsius for 10 to 180 seconds) on at least a portion of the textile fiber product to which a post-treating agent has been applied.

By performing a post-treatment, a textile fiber product with additional effects such as improved feeling, improved image fastness, improved sliding property, prevention of electrification, prevention of discoloration, and improved flame retardancy depending on the post-treating agent applied can be obtained.

### EXAMPLES

The present invention is hereinafter described in further detail with reference to Examples, to which, however, the present invention is not limited. Note that “parts” as mentioned in Examples and elsewhere mean “parts by weight” unless otherwise stated.

### Preparation of Binder Composition for Ink Adsorption Layer Formation 1

5 parts of MIZUKASIL P78D (trade name for silicon dioxide [specific surface area: 360 m²/g]; manufactured by Mizusawa Industrial Chemicals Ltd., 40 parts of RIKABOND FK-471 (trade name for acrylic resin; manufactured by Japan Coating Resin Co., Ltd.), 1 part of 20% aqueous solution of sodium hexametaphosphate, 3 parts of an acrylic thickener manufactured by Matsui Shikiso Chemical Co., Ltd., 10 parts of ethylene glycol, 3 parts of urea, 0.5 parts of aqueous ammonia, and 37.5 parts of water were blended to yield a homogeneous binder composition for ink adsorption layer formation 1.

### Preparation of Binder Composition for Ink Adsorption Layer Formation 2

5 parts of MIZUKASIL P78D, 20 parts of titanium dioxide, 40 parts of RIKABOND FK-471, 3 parts of Matsum in Fixer N (trade name for block isocyanate compound; manufactured by Matsui Shikiso Chemical Co., Ltd.), 1 part of 20% aqueous solution of sodium hexametaphosphate, 3 parts of the acrylic thickener, 8 parts of ethylene glycol, 3 parts of urea, 0.5 parts of aqueous ammonia, and 16.5 parts of water were blended to yield a homogeneous binder composition for ink adsorption layer formation 2.

### Preparation of Binder Composition for Ink Adsorption Layer Formation 3

5 parts of MIZUKASIL P78D, 20 parts of titanium dioxide, 40 parts of RIKABOND FK-471, 3 parts of Matsum in Fixer N, 1 part of 80% aqueous solution of didecyldimethylammonium chloride, 1 part of 20% aqueous solution of sodium hexametaphosphate, 3 parts of the acrylic thickener, 8 parts of ethylene glycol, 3 parts of urea, 0.5 parts of aqueous ammonia, and 15.5 parts of water were blended to yield a homogeneous binder composition for ink adsorption layer formation 3.

### Preparation of Binder Composition for Ink Adsorption Layer Formation 4

5 parts of MIZUKASIL P78D, 40 parts of RIKABOND FK-471, 3 parts of Matsumin Fixer N, 10 parts of Decroline Soluble Conc. (trade name for discharging agent; manufactured by BASF), 1 part of 20% aqueous solution of sodium hexametaphosphate, 3 parts of the acrylic thickener, 10 parts of ethylene glycol, 3 parts of urea, 0.5 parts of aqueous ammonia, and 24.5 parts of water were blended to yield a homogeneous binder composition for ink adsorption layer formation 4.

### Preparation of Binder Composition for White Masking Layer Formation

30 parts of titanium dioxide, 30 parts of RIKABOND FK-471, 3 parts of Matsumin Fixer N, 1 part of 20% aqueous solution of sodium hexametaphosphate, 3 parts of the acrylic thickener, 10 parts of ethylene glycol, 3 parts of urea, 0.5 parts of aqueous ammonia, and 19.5 parts of water were blended to yield a homogeneous binder composition for white masking layer formation.

### Preparation of Binder Composition for Sublimation Contamination Prevention Layer Formation

8 parts of activated charcoal, 30 parts of RIKABOND FK-471, 3 parts of Matsumin Fixer N, 5 parts of the acrylic thickener, 10 parts of ethylene glycol, 3 parts of urea, 0.5 parts of aqueous ammonia, and 40.5 parts of water were blended to yield a homogeneous binder composition for sublimation contamination prevention layer formation.

### Preparation of Pigment Dispersion

A mixture of 20 parts of pigment (yellow, magenta, cyan, or black pigment), 8 parts of JONCRYL 57J (trade name for water-soluble polymeric dispersing agent; manufactured by BASF Japan Ltd.), 48.5 parts of water, 20 parts of diethylene glycol, 3 parts of urea, and 0.5 parts of SN-DEFOAMER 777 (trade name for defoaming agent; manufactured by San Nopco Limited) was wet-dispersed using a milling machine, and filtered through a membrane filter having a pore diameter of 1.0 micro m, to yield a pigment dispersion in each color.

The yellow, magenta, cyan, and black pigments used were C.I. Pigment Yellow 17, C.I. Pigment Red 122, C.I. Pigment Blue 15:3, and Carbon Black, respectively.

### Preparation of Aqueous Pigment Ink 1

20 parts of pigment dispersion (the yellow, magenta, cyan, or black pigment dispersion), 20 parts of glycerin, 20 parts of ADEKA BONTIGHTER HUX-370 (trade name for self-emulsifying urethane resin; manufactured by ADEKA Corporation), 5 parts of ethylene glycol, and 35 parts of water were blended with stirring to yield an aqueous pigment ink 1 in each color.

### Preparation of Aqueous Pigment Ink 2

20 parts of pigment dispersion (the yellow, magenta, cyan, or black pigment dispersion), 20 parts of glycerin, 20 parts of ADEKA BONTIGHTER HUX-370, 5 parts of Matsum in Fixer N, 5 parts of ethylene glycol, and 33 parts of water were blended with stirring to yield an aqueous pigment ink 2 in each color.

### Example 1

### Formation of Ink Adsorption Layer 1

The binder composition for ink adsorption layer formation 1 was printed on a white cotton cloth at an application rate of 74 g/m² by hand printing (printed once) using a 150-mesh screen plate, and drying was performed at 60 degrees Celsius for 10 minutes, to form an ink adsorption layer 1 in the same shape as the JIS X9201:2001 N3 (fruit basket) image.

### Image Formation

The aqueous pigment ink 1 in each color (yellow, magenta, cyan, and black pigment) was filled in an inkjet printing machine manufactured by Mastermind Co., Ltd. (MMP8130), and the JIS X9201:2001 N3 (fruit basket) image was inkjet-printed with the aqueous pigment ink 1 on the dried ink adsorption layer 1 so that the region of the image would coincide substantially with the region of the ink adsorption layer 1.

After inkjet printing, the cotton cloth was dried at 60 degrees Celsius for 10 minutes and then heat treated at 160 degrees Celsius for 2 minutes; a colored cloth with a bleedingless, brilliant, densely colored N3 (fruit basket) image, which is soft in feeling, formed thereon was obtained.

### Fastness Test

The colored cloth obtained was subjected to a washing fastness test in accordance with the JIS L-0217 103 method five times (5-grade rating method); good washing fastness with a rating of grade 3-4 was exhibited.

(Example 2

### Formation of Ink Adsorption Layer 2

The binder composition for ink adsorption layer formation 1 was printed on a black cotton cloth at an application rate of 191 g/m² by hand printing (printed twice) using a 100-mesh screen plate, and drying was performed at 60 degrees Celsius for 10 minutes, to form an ink adsorption layer 2 in the same shape as the JIS X9201:2001 N3 (fruit basket) image.

### Image Formation

Using an inkjet printing machine (MMP8130) filled with the aqueous pigment ink 1 in each color, the JIS X9201:2001 N3 (fruit basket) image was inkjet-printed with the aqueous pigment ink 1 on the dried ink adsorption layer 2 so that the region of the image would coincide substantially with the region of the ink adsorption layer 2.

After inkjet printing, the cotton cloth was dried at 60 degrees Celsius for 10 minutes and then heat treated at 160 degrees Celsius for 2 minutes; a colored cloth with a bleedingless, brilliant, densely colored N3 (fruit basket) image, which is soft in feeling and excellent in black cotton cloth base color concealing performance, formed thereon was obtained.

### Fastness Test

The colored cloth obtained was subjected to a washing fastness test in the same manner as Example 1; good washing fastness with a rating of grade 3-4 was exhibited.

### Example 3

### Formation of Ink Adsorption Layer 3

The binder composition for ink adsorption layer formation 2 was printed on a black cotton cloth at an application rate of 108 g/m² by hand printing (printed once) using a 100-mesh screen plate, to form an ink adsorption layer 3 in the same shape as the JIS X9201:2001 N3 (fruit basket) image.

### Image Formation

The aqueous pigment ink 2 in each color (yellow, magenta, cyan, and black pigment) was filled in an inkjet printing machine (MMP8130), and the JIS X9201:2001 N3 (fruit basket) image was inkjet-printed with the aqueous pigment ink 2 on the ink adsorption layer 3 in a wet state so that the region of the image would coincide substantially with the region of the ink adsorption layer 3.

After printing, the cotton cloth was dried at 100 degrees Celsius for 5 minutes and then heat treated at 160 degrees Celsius for 3 minutes; a colored cloth with a bleedingless, more brilliant (than in Example 2), densely colored N3 (fruit basket) image, which is excellent in black cotton cloth base color concealing performance and softer in feeling (than in Example 2), formed thereon was obtained.

### Fastness Test

The colored cloth obtained was subjected to a washing fastness test in the same manner as Example 1; good fastness with a rating of grade 3-4 was exhibited.

### Example 4

### Formation of Ink Adsorption Layer 4

The binder composition for ink adsorption layer formation 3 was printed on a black cotton cloth at an application rate of 106 g/m² by hand printing (printed once) using a 100-mesh screen plate, to form an ink adsorption layer 4 in the same shape as the JIS X9201:2001 N3 (fruit basket) image.

### Image Formation

Using an inkjet printing machine (MMP8130) filled with the aqueous pigment ink 2 in each color (yellow, magenta, cyan, and black pigment), the JIS X9201:2001 N3 (fruit basket) image was inkjet-printed with the aqueous pigment ink 2 on the ink adsorption layer 4 in a wet state so that the region of the image would coincide substantially with the region of the ink adsorption layer 4.

After printing, the cotton cloth was dried at 100 degrees Celsius for 5 minutes and then heat treated at 160 degrees Celsius for 3 minutes; a colored cloth with a bleedingless, more brilliant (than in Example 3), densely colored N3 (fruit basket) image, which is excellent in black cotton cloth base color concealing performance and softer in feeling (than in Example 2), formed thereon was obtained.

### Fastness Test

The colored cloth obtained was subjected to a washing fastness test in the same manner as Example 1; good fastness with a rating of grade 3-4 was exhibited.

### Example 5

### Formation of Ink Adsorption Layer 5

The binder composition for ink adsorption layer formation 4 was printed on a black cotton cloth at an application rate of 111 g/m² by hand printing (printed once) using a 100-mesh screen plate, to form an ink adsorption layer 5 on the entire surface of one face of the black cotton cloth.

### Image Formation

Using an inkjet printing machine (MMP8130) filled with the aqueous pigment ink 2 in each color (yellow, magenta, cyan, and black pigment), the JIS X9201:2001 N3 (fruit basket) image was inkjet-printed with the aqueous pigment ink 2 on the ink adsorption layer 5 in a wet state.

After printing, the cotton cloth was dried at 100 degrees Celsius for 5 minutes and then heat treated at 160 degrees Celsius for 3 minutes; a colored cloth with a bleedingless, brilliant, densely colored N3 (fruit basket) image, which is softer in feeling (than in Example 2), formed thereon was obtained.

The portion, other than the N3 (fruit basket) image, of the ink adsorption layer 5 of the black cotton cloth, became white due to color discharge.

### Fastness Test

The colored cloth obtained was subjected to a washing fastness test in the same manner as Example 1; good fastness with a rating of grade 3-4 was exhibited.

### Example 6

### Formation of White Masking Layer

The binder composition for white masking layer formation was printed on a black cotton cloth at an application rate of 103 g/m² by hand printing (printed once) using a 100-mesh screen plate, and drying was performed at 60 degrees Celsius for 10 minutes, to form a white masking layer in the same shape as the JIS X9201:2001 N3 (fruit basket) image.

### Formation of Ink Adsorption Layer 6

The binder composition for ink adsorption layer formation 1 was printed on the dried white masking layer at an application rate of 52 g/m² by hand printing (printed once) using a 150-mesh screen plate, to form an ink adsorption layer 6 in a region that coincided substantially with the region of the white masking layer.

### Image Formation

Using an inkjet printing machine (MMP8130) filled with the aqueous pigment ink 2 in each color (yellow, magenta, cyan, and black pigment), the JIS X9201:2001 N3 (fruit basket) image was inkjet-printed with the aqueous pigment ink 2 on the ink adsorption layer 6 in a wet state so that the region of the image would coincide substantially with the region of the ink adsorption layer 6.

After printing, the cotton cloth was dried at 100 degrees Celsius for 5 minutes and then heat treated at 160 degrees Celsius for 3 minutes; a colored cloth with a bleedingless, more brilliant (than in Example 2), densely colored N3 (fruit basket) image, which is excellent in black cotton cloth base color concealing performance and soft in feeling, formed thereon was obtained.

### Fastness Test

The colored cloth obtained was subjected to a washing fastness test in the same manner as Example 1; good fastness with a rating of grade 3-4 was exhibited.

### Example 7

### Formation of Sublimation Contamination Prevention Layer

The binder composition for sublimation contamination prevention layer formation was printed on a black polyester cloth (dyed with a disperse dye) at an application rate of 84 g/m² by hand printing (printed once) using a 120-mesh screen plate, and drying was performed at 60 degrees Celsius for 10 minutes, to form a sublimation contamination prevention layer in the same shape as the JIS X9201:2001 N3 (fruit basket) image.

### Formation of Ink Adsorption Layer 7

The binder composition for ink adsorption layer formation 2 was printed on the dried sublimation contamination prevention layer at an application rate of 172 g/m² by hand printing (printed twice) using a 100-mesh screen, and drying was performed at 60 degrees Celsius for 10 minutes, to form an ink adsorption layer 7 in a region that coincided substantially with the region of the sublimation contamination prevention layer.

### Image Formation

Using an inkjet printing machine (MMP8130) filled with the aqueous pigment ink 2 in each color (yellow, magenta, cyan, and black pigment), the JIS X9201:2001 N3 (fruit basket) image was inkjet-printed with the aqueous pigment ink 2 on the dried ink adsorption layer 7 so that the region of the image would coincide substantially with the region of the ink adsorption layer 7.

After inkjet printing, the polyester cloth was dried at 60 degrees Celsius for 10 minutes and then heat treated at 160 degrees Celsius for 2 minutes; a colored cloth with a bleedingless, brilliant, densely colored N3 (fruit basket) image, which is excellent in black polyester cloth base color concealing performance and soft in feeling, formed thereon was obtained.

The image formed showed no contamination with the disperse dye in the black polyester cloth.

### Fastness Test

The colored cloth obtained was subjected to a washing fastness test in the same manner as Example 1; good fastness with a rating of grade 3-4 was exhibited.

### Example 8

### Formation of Sublimation Contamination Prevention Layer

A sublimation contamination prevention layer was formed on a black polyester cloth in the same manner as Example 7.

### Formation of White Masking Layer

The binder composition for white masking layer formation was printed on the dried sublimation contamination prevention layer at an application rate of 94 g/m² by hand printing (printed once) using a 100-mesh screen plate, and drying was performed at 60 degrees Celsius for 10 minutes, to form a white masking layer in a region that coincided substantially with the region of the sublimation contamination prevention layer.

### Formation of Ink Adsorption Layer 8

The binder composition for ink adsorption layer formation 1 was printed on the dried white masking layer at an application rate of 64 g/m² by hand printing (printed once) using a 150-mesh screen plate, to form an ink adsorption layer 8 in a region that coincided substantially with the region of the white masking layer.

### Image formation

Using an inkjet printing machine (MMP8130) filled with the aqueous pigment ink 2 in each color (yellow, magenta, cyan, and black pigment), the JIS X9201:2001 N3 (fruit basket) image was inkjet-printed with the aqueous pigment ink 2 on the ink adsorption layer 8 in a wet state so that the region of the image would coincide substantially with the region of the ink adsorption layer 8.

After inkjet printing, the polyester cloth was dried at 100 degrees Celsius for 5 minutes and then heat treated at 160 degrees Celsius for 3 minutes; a colored cloth with a bleedingless, brilliant, densely colored N3 (fruit basket) image, which is excellent in black polyester cloth base color concealing performance and soft in feeling, formed thereon was obtained.

The image formed showed no contamination with the disperse dye in the black polyester cloth.

### Fastness Test

The colored cloth obtained was subjected to a washing fastness test in the same manner as Example 1; good fastness with a rating of grade 3-4 was exhibited.

### Examples 9 to 16

### Post-Treatment Step

Each of the colored cloths obtained in Examples 1 to 8 was padded with a post-treating agent consisting essentially of 3 parts of Faster XA (trade name for acrylic resin emulsion; manufactured by Matsui Shikiso Chemical Co., Ltd.), 5 parts of Abrasi on XF (trade name for silicone-based softening agent; manufactured by Matsui Shikiso Chemical Co., Ltd.), and 92 parts of water at a wringing rate of 65%, and dried at 100 degrees Celsius for 3 minutes, after which a heat treatment was performed at 160 degrees Celsius for 1 minute.

When tested in the same manner as the washing fastness tests performed in the various Examples, each post-treated cloth obtained was found to have fastness improved by approximately 0.5 grades and a softener in feeling, compared with the non-post-treated colored cloth.

### Comparative Example 1

The aqueous pigment ink 1 in each color (yellow, magenta, cyan, and black pigment) was filled in an inkjet printing machine (MMP8130), and the JIS X9201:2001 N3 (fruit basket) image was inkjet-printed with the aqueous pigment ink 1 on a white cotton cloth; the quality was unsatisfactory, showing severe ink bleeding, with a non-brilliant image.

### Comparative Example 2

Using an inkjet printing machine (MMP8130) filled with the aqueous pigment ink 1 in each color (yellow, magenta, cyan, and black pigment), the JIS X9201:2001 N3 (fruit basket) image was inkjet-printed with the aqueous pigment ink 1 on a black cotton cloth; the quality was unsatisfactory, showing severe ink bleeding, with a non-brilliant image lacking concealing performance.

### Comparative Example 3

### Preparation of Binder Composition for Ink Adsorption Layer Formation NG1

40 parts of RIKABOND FK-471, 3.5 parts of the acrylic thickener, 10 parts of ethylene glycol, 3 parts of urea, 0.5 parts of aqueous ammonia, and 43 parts of water were blended to yield a homogeneous binder composition for ink adsorption layer formation NG1.

### Formation of Ink Adsorption Layer NG1

In the same manner as Example 2, the binder composition for ink adsorption layer formation NG1 was printed on a black cotton cloth at an application rate of 183 g/m² by hand printing (printed twice) using a 100-mesh screen plate, and drying was performed at 60 degrees Celsius for 10 minutes, to form an ink adsorption layer NG1 in the same shape as the JIS X9201:2001 N3 (fruit basket) image.

### Image Formation

Using an inkjet printing machine (MMP8130) filled with the aqueous pigment ink 1 in each color (yellow, magenta, cyan, and black pigment), the JIS X9201:2001 N3 (fruit basket) image was inkjet-printed with the aqueous pigment ink 1 on the dried ink adsorption layer NG1 so that the region of the image would coincide substantially with the region of the ink adsorption layer NG1.

After inkjet printing, the cotton cloth was dried at 60 degrees Celsius for 10 minutes and then heat treated at 160 degrees Celsius for 3 minutes; as in Comparative Example 2, the quality was unsatisfactory, showing severe ink bleeding, with a non -brilliant image lacking concealing performance.

### Comparative Example 4

### Preparation of Binder Composition for Ink Adsorption Layer Formation NG2

5 parts of MIZUKASIL P-603 (trade name for silicon dioxide [specific surface area: 40 m²/g]; manufactured by Mizusawa Industrial Chemicals Ltd.), 40 parts of RIKABO ND FK-471, 1 part of 20% aqueous solution of sodium hexametaphosphate, 3 parts of the acrylic thickener, 10 parts of ethylene glycol, 3 parts of urea, 0.5 parts of aqueous ammonia, and 37.5 parts of water were blended to yield a homogeneous binder composition for ink adsorption layer formation NG2.

### Formation of Ink Adsorption Layer NG2

In the same manner as Example 2, the binder composition for ink adsorption layer formation NG2 was printed on a black cotton cloth at an application rate of 179 g/m² by hand printing (printed twice) using a 100-mesh screen plate, and drying was performed at 60 degrees Celsius for 10 minutes, to form an ink adsorption layer NG2 in the same shape as the JIS X9201:2001 N3 (fruit basket) image.

### Image Formation

The aqueous pigment ink 2 in each color (yellow, magenta, cyan, and black pigment) was filled in an inkjet printing machine (MMP8130), and the JIS X9201:2001 N3 (fruit basket) image was inkjet-printed with the aqueous pigment ink 2 on the dried ink adsorption layer NG2 so that the region of the image would coincide substantially with the region of the ink adsorption layer NG2.

After inkjet printing, the cotton cloth was dried at 60 degrees Celsius for 10 minutes and then heat treated at 160 degrees Celsius for 3 minutes; the quality was unsatisfactory, showing bleeding and mottling, and lacking brilliancy.

### Comparative Example 5

### Formation of Ink Adsorption Layer NG3

The binder composition for white masking layer formation was printed on a black cotton cloth at an application rate of 187 g/m² by hand printing (printed twice) using a 100-mesh screen plate to form an ink adsorption layer NG3 in the same shape as the JIS X9201:2001 N3 (fruit basket) image.

### Image Formation

In the same manner as Example 2, using an inkjet printing machine (MMP8130) filled with the aqueous pigment ink 2 in each color (yellow, magenta, cyan, and black pigment), the JIS X9201:2001 N3 (fruit basket) image was inkjet-printed with the aqueous pigment ink 2 on an ink adsorption layer NG3 in a wet state so that the region of the image would coincide substantially with the region of the ink adsorption layer NG3.

After printing, the cotton cloth was dried at 100 degrees Celsius for 5 minutes and then heat treated at 160 degrees Celsius for 3 minutes; no satisfactory quality was obtained, showing bleeding and mottling, lacking brilliancy, and having an insufficient color density.

What is claimed is:

1. A method for image formation on a textile fiber product comprising:
an ink adsorption layer formation step for forming an ink adsorption layer by screen-printing a liquid or pasty binder composition for ink adsorption layer formation on a required portion of the textile fiber product directly or via another layer, and
an inkjet step for forming an image by applying, using an inkjet process, an aqueous pigment ink to the ink adsorption layer formed through the ink adsorption layer formation step,
wherein the binder composition for ink adsorption layer formation contains inorganic porous microparticles having a specific surface area of not less than 200 m²/g to adsorb the aqueous pigment ink applied using the inkjet process.

2. The method for image formation according to claim 1, wherein the region of the ink adsorption layer formed through the ink adsorption layer formation step and the region of the image formed through the inkjet step coincide substantially with each other.

3. The method for image formation according to claim 1, wherein the required portion of the textile fiber product is chromatic.

4. The method for image formation according to claim 1, wherein the ink adsorption layer is in a wet state when applying the aqueous pigment ink to the ink adsorption layer using an inkjet process.

5. The method for image formation according to claim 1, wherein the inorganic porous microparticles are at least one kind of inorganic porous microparticles selected from among silicon dioxide, aluminosilicate and bentonite, and those cationized with a cationic compound.

6. The method for image formation according to claim 1, wherein the binder composition for ink adsorption layer formation contains titanium dioxide to improve the concealing performance of the ink adsorption layer.

7. The method for image formation according to claim 1, wherein the binder composition for ink adsorption layer formation contains a cationic compound.

8. The method for image formation according to claim 1, wherein the binder composition for ink adsorption layer formation contains a discharging agent.

9. The method for image formation on a textile fiber product according to any one of claim 1, wherein the ink adsorption layer formation step is for forming an ink adsorption layer by screen-printing a liquid or pasty binder composition for ink adsorption layer formation on the required portion of the textile fiber product directly or via a white masking layer, the white masking layer containing titanium dioxide.

10. The method for image formation according to claim 1, wherein the ink adsorption layer formation step is for forming an ink adsorption layer by screen-printing a liquid or pasty binder composition for ink adsorption layer formation on the required portion of the textile fiber product directly or via a sublimation contamination prevention layer o r a white masking layer formed via a sublimation contamination prevention layer, the sublimation contamination prevention layer containing activated charcoal.

11. The method for image formation according to claim 1, wherein the amount of the binder composition for ink adsorption layer formation applied to the textile fiber product directly or via another layer is 40 to 200 g/m².

12. The method for image formation according to claim 1, wherein the aqueous pigment ink used for the step for image formation contains at least:
(A) a pigment,
(B) a water-soluble polymeric dispersing agent,
(C) an aqueous liquid as a solvent or disperse medium,
(D) a self-emulsifying urethane resin, and
(E) a block isocyanate compound.

13. The method for image formation according to claim 1, having a heat treatment step for performing a heat treatment at 100 to 220 degrees Celsius for 1 to 10 minutes for at least the portion of the textile fiber product with an image formed thereon with the aqueous pigment ink.

14. The method for image formation according to claim 1, having a post-treatment step for performing a post-treatment by applying a post-treating agent to at least the portion of the textile fiber product with an image formed thereon with the aqueous pigment ink.

15. The method for image formation according to claim 14, wherein the post-treating agent is at leas t one kind of acrylic resin emulsion, urethane resin emulsion, crosslinking agent, plasticizer, surfactant, flame retardant, silicone-based softening agent, and fluorine-based water repellent, and
the post-treatment step comprises performing a heat treatment at 100 to 180 degrees Celsius for 10 to 180 seconds for at least the portion of the textile fiber product with the post-treating agent applied thereto.

16. A textile fiber product having an image formed thereon, wherein the image formation process comprises:
an ink adsorption layer formation step for forming an ink adsorption layer by screen-printing a liquid or pasty binder composition for ink adsorption layer formation on a required portion of the textile fiber product directly or via another layer, and
an inkjet step for forming an image by applying, using an inkjet process, an aqueous pigment ink to the ink adsorption layer formed through the ink adsorption layer formation step,
wherein the binder composition for ink adsorption layer formation contains inorganic porous microparticles having a specific surface area of not less than 200 m²/g to adsorb the aqueous pigment ink applied using the inkjet process.
